(19) United States
(12) Patent Application Publication
(10) Pub. No.: US 2026/0209486 A1
(43) Pub. Date: Jul. 23, 2026

(54) RUBBER COMPOSITION READY FOR CROSSLINKING

(71) Applicant: RUBBERGREEN INDUSTRIE, Frameries (BE)

(72) Inventors: Saïd Seghar, Valenciennes (FR); Olivier Prud'homme, Saint Symphorien (BE)

(73) Assignee: RUBBERGREEN INDUSTRIE, Frameries (BE)

(21) Appl. No.: 19/142,068

(22) PCT Filed: Dec. 26, 2023
(86) PCT No.: PCT/EP2023/087796

§ 371 Date: Jun. 20, 2025

(30) Foreign Application Priority Data
Dec. 23, 2022 (BE) 2022/6082

(51) Int. Cl. C08L 17/00; C08K 3/06; C08K 3/22; C08K 5/09; C08K 5/47

(52) U.S. Cl. CPC C08L 17/00; C08K 3/06; C08K 3/22; C08K 5/09; C08K 5/47; C08K 2003/2296

(57) ABSTRACT

This invention relates to a composition which comprises:
A quantity of rubber of between 30% and 90% by weight;
An activating agent in an amount of between 0.1% and 10% by weight;
A vulcanising agent which comprises sulphur, in an amount of between 0.5 and 5% by weight;
   characterised in that said composition comprises a total amount of bound sulphur of at least 0.25% by weight, and an amount of free sulphur of between 0.1% and 5% by weight.

This invention relates to a ready-to-crosslink rubber-based composition, to its manufacturing process, and to its uses.

Rubber is a material widely used in many fields, for example, in aeronautics, the automotive industry, in construction, and civil engineering.

Currently, it would be advantageous to be able to recover used rubber materials that are available to the user in order to reintegrate them into a production cycle for value-added end products. To achieve this, the used rubber material must be capable of being recovered and allow the production of these end products, while retaining mechanical properties that are at least equivalent to, or even better than, products made from virgin (raw) rubber (properties suitable for the application), i.e., non-recycled rubber.

One benefit involves the recovery of stored waste, end-of-life products, or production scrap. This also reduces the manufacturing costs of final products using recovered used rubber materials.

When rubber materials are used, they may contain a certain amount of bound sulphur, since they are the result of a vulcanisation process, when sulphur is used as a vulcanising agent. This material can be recovered and lead to final products based on these vulcanised rubber materials.

Generally, current rubber processing systems do not allow for the rapid, easy, and low-cost recovery of vulcanised used rubber materials.

Furthermore, vulcanised rubber waste is rarely recycled, if at all. Indeed, recycling processes for this type of waste are expensive and difficult to implement.

Rubber produced by these recycling processes generally has less desirable mechanical properties, which also results in the production of end products with inadequate properties. In an attempt to achieve minimal recovery of this vulcanised rubber waste, it is possible to provide a composition that primarily comprises virgin rubber with a small amount of vulcanised rubber, which is still insufficient given the current economic situation.

Another disadvantage of the prior art is that several industrial steps are required to produce a vulcanised material from waste or used materials. The user may therefore have to identify sources of used raw materials and then process them by companies specialising in devulcanisation. The addition of the final ingredients required for vulcanisation of the material may also be carried out by another party, which greatly complicates preparation and increases production costs.

There is therefore a real need to provide a rubber-based composition that is ready to be directly vulcanised, at a low cost, while optimising the use of used rubber materials and retaining advantageous mechanical properties, or even improved ones, compared with virgin rubber-based compositions.

To solve this problem, this invention provides a ready-to-crosslink rubber-based composition, preferably in the form of an extruded strip, said composition comprising:
a) A total quantity of rubber of between 30% and 90% by weight or between 30 and 99% by weight;
b) A rubber activating agent in an amount of between 0.1% and 10% by weight;
c) A vulcanising agent that comprises sulphur, in an amount of between 0.5 and 5% by weight;
   characterised in that said ready-to-crosslink composition comprises a total amount of bound sulphur of at least 0.25%, preferably between 0.25% and 10% by weight, more preferably between 0.25% and 5% by weight, preferably between 0.1 and 5% by weight, and an amount of free sulphur of between 0.1 and 5%, each % by weight mentioned above being expressed relative to the total weight of the composition.

The composition according to the invention solves the above problems in that it contains an amount of bound sulphur of between 0.1 and 10% by weight, relative to the total weight of said composition.

This amount of bound sulphur means that a (major) portion of the rubber comes from elastomer waste that has already been vulcanised (entirely or partially) and which therefore contains a certain amount of bound sulphur.

Advantageously, the amount of bound sulphur is provided by the rubber supply, a major portion of which comes from elastomer waste that has already been vulcanised and subsequently devulcanised, preferably by (thermo)mechanical means, and which therefore contains a certain amount of bound sulphur. In this embodiment, a portion of the sulphur bonds is broken but remains (partially bound), which is also part of this invention. These bonds may be S—S or S—C bonds.

The amounts of bound sulphur expressed above also apply to the aforementioned embodiments.

Preferably, this devulcanised elastomer waste makes it possible to provide a composition according to the invention.

Preferably, said composition comprises a total amount of rubber of between 30% and 90% by weight or between 30 and 99% by weight, preferably between 40 and 99% by weight, more preferably between 45 and 99% by weight, and even more preferably between 50 and 99% by weight.

The invention makes it possible to recover substantial quantities of rubber that can come from the recycling sector. This is particularly advantageous given that the prior art is limited to smaller quantities in the proposed compositions.

This invention also preferentially targets a composition that is in the form of a strip that comprises a significant total amount of rubber.

The preferred mass ratio of free sulphur to bound sulphur of the composition according to the invention is between 0.1 and 10, preferably between 1 and 2, when advantageously the rubber material (rubber) consists of 100% devulcanised rubber.

The preferred mass ratio of free sulphur to bound sulphur of the composition according to the invention is between 0.2 and 15, preferably between 1.5 and 3, when the rubber material (rubber) comprises 50% by weight, preferably less than 50% by weight, more preferably less than 40% by weight of accelerated virgin rubber (comprising at least the activating and vulcanising agent) and 50% by weight of devulcanised rubber, preferably more than 50% by weight, more preferably more than 55% by weight, even more preferably more than 60% by weight of devulcanised rubber.

Even more advantageously, the preferred mass ratio of free sulphur to bound sulphur in the composition according to the invention is between 0.1 and 5, preferably between 0.5 and 1, when the rubber material comprises 50% virgin rubber (non-accelerated) and 50% devulcanised rubber.

It is also understood that the majority of the free sulphur comes from the vulcanising agent, which includes sulphur, or possibly from the vulcanisation accelerator, which also provides a quantity of free sulphur.

Finally, the ready-to-crosslink rubber-based composition is formulated so that it already contains the necessary amounts of activating agent, for example zinc oxide (ZnO), and vulcanising agent, preferably consisting of sulphur, and possibly an accelerator, which allows for the direct vulcanisation of the composition. This composition is therefore advantageous for the user, who can quickly and easily use the composition according to the invention.

According to a particularly advantageous embodiment, the composition is in the form of an extruded strip, which is also ready to be easily and directly vulcanised. When the composition is an extruded strip, it is in the form of a ready-to-use paste.

In a preferred embodiment of the invention, the composition, preferably in the form of an extruded strip, has a viscosity of between 20 and 85 Mooney, preferably between 35 and 80 Mooney, measured according to ISO-289 or ASTM D1646-19a.

Rubber is a viscoelastic material whose behaviour lies somewhere between that of a viscous fluid and an elastic solid. Measuring Mooney viscosity makes it possible to predict the material's deformation and flow behaviour under stress. The composition according to the invention, having a viscosity between 20 and 85 Mooney, therefore possesses deformation and flow resistance under stress, making it ideal for the intended applications. These applications may, for example, involve the manufacture of automotive tyres, seals, elastic (anti-vibration) pads (railways), etc.

In a preferred embodiment of the invention, the composition further comprises a rubber vulcanisation accelerator in an amount between 0.5% and 5% by weight, relative to the total weight of said composition.

Particularly advantageously, the vulcanisation accelerator is chosen from the group consisting of N-cyclohexyl-2-benzothiazole-sulfenamide (CBS), 2,2-dibenzothiazole disulfide (MBTS), tetramethyl thiuram disulfide (TMTD) and any equivalent.

The presence of a vulcanisation accelerator accelerates the vulcanisation process, preferably by adding free sulphur to the composition according to the invention. Depending on the desired mechanical properties and/or the chemical composition of the composition, and the processing method adopted, it may be advantageous to modify the amount of vulcanisation accelerator. The vulcanisation accelerator accelerates the vulcanisation reaction and provides a composition that will be activated (i.e., ready to be effectively crosslinked/vulcanised).

In a preferred embodiment of the invention, the composition further comprises additives selected from the group consisting of reinforcing fillers, diluting fillers, fatty acids, preferably stearic acid, plasticisers, anti-ozone protectors, antioxidants, oils, and mixtures thereof.

The presence of additives makes it possible to provide a composition intended for use in a final product that must exhibit certain technical characteristics. The choice and quantity of additives are guided by the rheological, physicochemical, and mechanical characteristics of the products to be manufactured with the composition. Finally, some additives protect the composition from possible degradation.

In an advantageous embodiment, the activating agent is zinc oxide.

In a preferred embodiment of the invention, said rubber is derived from a devulcanised rubber, preferably by (thermo)mechanical means, which is present in an amount of between 51% and 100% by weight, preferably between 55% and 100% by weight, more preferably between 60% and 100% by weight, even more preferably between 70% and 100% by weight, advantageously between 80% and 100% by weight, more advantageously between 90% and 100% by weight, relative to the total weight of rubber.

Advantageously, said rubber comprises a virgin rubber, which is present in an amount of between 10 and 49% by weight, preferably between 10% and 40% by weight, more preferably between 10% and 35% by weight, even more preferably between 10% and 30% by weight, advantageously between 10% and 25% by weight, more advantageously between 10% and 20% by weight, relative to the total weight of rubber.

According to a preferred embodiment, devulcanised rubber is predominantly present in said rubber.

Advantageously, said rubber derived from said devulcanised rubber has a bound sulphur content of at least 0.25% by weight, preferably between 0.25% and 10% by weight, more preferably between 0.25% and 5% by weight, even more preferably between 1% and 2% by weight, determined before addition to said composition.

According to an even more advantageous embodiment, the devulcanised rubber is primarily sourced from a recycling channel. In other words, used rubber will be recycled by being processed to be preferably supplied in the form of granules, chips, or powders. Furthermore, these types of rubber have, during their initial use, been vulcanised and then transformed into granules, chips, or powders for recovery.

This invention should advantageously use recycled and vulcanised rubber in the form of granules, chips, or powders, and optionally further devulcanised by (thermo)mechanical means, to be included in the composition provided.

It is therefore possible for the rubber to consist of 100% by weight of recycled rubber, preferably devulcanised rubber, which is particularly advantageous.

In a preferred embodiment of the invention, said devulcanised rubber is derived from vulcanised elastomer waste, preferably selected from the group consisting of ethylene-propylene-diene monomer (EPDM), styrene-butadiene (SBR), natural rubber (NR), synthetic isoprene (IR), and mixtures thereof, preferably in the form of chips, granules, or powders.

The devulcanised rubber derived from waste comprising at least one elastomer waste product is preferably in the form of chips, granules, or powders.

EPDM, SBR, NR, and IR elastomers represent the majority of the constituents found in elastomer waste. More specifically, these materials may originate, in particular, from waste lorry tyres, car tyres, aircraft tyres, seals, or elastic membranes.

In a preferred embodiment of the invention, said rubber is obtained by mixing an amount of between 50% and 90% by weight of devulcanised rubber, and an amount of between 10% and 50% by weight of virgin rubber, said % by weight being expressed relative to the total amount of rubber.

Preferably, the devulcanised rubber comprises at least 0.25% by weight, preferably between 0.25% and 10% by weight, more preferably between 0.25% and 5% by weight of bound sulphur.

Again and advantageously, the devulcanised rubber of this invention is primarily (completely) sourced from a recycling channel. In other words, used rubber will be recycled by processing it to be preferably supplied in the form of granules, chips, or powders. Moreover, these types of rubber were, upon initial use, vulcanised and then transformed into granules, chips, or powders for their recovery.

This invention should advantageously use recycled rubber in the form of vulcanised granules, chips, or powders, which will then have been devulcanised to be included in the composition provided.

According to another preferred embodiment, it may be useful to provide a ready-to-crosslink rubber-based composition which comprises at least 50%, preferably at least 51% of recycled rubber, preferably devulcanised to target certain applications. A mixture between devulcanised rubber and virgin rubber may therefore be made to provide the total rubber quantity.

Other embodiments of the composition according to the invention are indicated in the appended claims.

The invention also relates to a method for manufacturing a composition, preferably the composition according to the invention, ready-to-crosslink and rubber-based, to form an extruded strip, said method comprising the following steps:
a) Selecting a first fraction comprising at least 50% by weight, preferably at least 55% by weight, more preferably at least 60% by weight of a vulcanised elastomer waste selected from the group consisting of ethylene-propylene-diene monomer (EPDM), styrene-butadiene (SBR), natural rubber (NR), synthetic isoprene (IR) and mixtures thereof, and wherein said vulcanised elastomer waste has a quantity of bound sulphur of at least 0.25% by weight, preferably between 0.25% and 10% by weight, more preferably between 0.25 and 5% by weight,
b) Devulcanisation by (thermo)chemical or (thermo)mechanical means of said first fraction to obtain a devulcanised material,
c) Optionally, selecting a second fraction comprising at least 30% by weight of a virgin elastomer selected from the group consisting of ethylene-propylene-diene monomer (EPDM), styrene-butadiene (SBR), natural rubber (NR), synthetic isoprene (IR) and mixtures thereof,
d) Optionally, adding said devulcanised material to said second fraction;
e) Mixing the material obtained in step b or step d, with at least one rubber activating agent and a vulcanising agent which comprises sulphur, with formation of a devulcanised mixture corresponding to said ready-to-crosslink rubber-based composition;
   characterised in that said ready-to-crosslink rubber-based composition obtained during the mixing of step (e) comprises at least 0.25% by weight, preferably between 0.25% and 10% by weight, more preferably between 0.25% and 5% by weight of bound sulphur, and between 0.25 and 2% by weight of free sulphur, relative to the total weight of said composition.

The method of the invention allows vulcanised elastomer waste to be recovered. This involves a specific devulcanisation process, preferably carried out (thermo)mechanically, preferably by shearing in an extruder. This devulcanisation will break certain S—S and/or C—S bonds in the waste.

The first fraction obtained can be transformed into chips, granules, or powders before devulcanisation. Thus, these vulcanised chips, granules, or powders are then devulcanised according to the method of the invention.

The first fraction can also be mixed with the second fraction depending on the intended applications.

Preferably, the selection of the second fraction may comprise at least 10% by weight, preferably 20% by weight, more preferably 30% by weight of a virgin elastomer chosen from the group consisting of ethylene-propylene-diene monomer (EPDM), styrene-butadiene (SBR), natural rubber (NR), synthetic isoprene (IR) and mixtures thereof.

Alternatively, when the material obtained in step b is mixed with the vulcanising agent and the activating agent, the material thus obtained can still be mixed with said second virgin fraction (virgin elastomer) which also comprises an activating agent and a vulcanising agent, to form the ready-to-crosslink composition according to the invention.

The method provided is efficient and easy to implement for a large number of rubber waste sources, while enabling them to be recovered at a competitive cost.

The devulcanisation step b of the method is preferably carried out mechanically, more preferably thermomechanically, preferably by shearing in an extruder.

In a preferred embodiment of the invention, the mixing step of step (e) is carried out by adding between 50% and 100% by weight of said devulcanised material, relative to the total weight of said composition.

The devulcanisation step b makes it possible to obtain a devulcanised material. It is possible in the method according to the invention to introduce all of this material into the mixing step of step (e). It is also possible to introduce only a portion of it, of at least 50% by weight, preferably at least 55% by weight, more preferably at least 60% by weight, advantageously at least 70% by weight, more advantageously at least 85% by weight, relative to the total weight of said composition.

In a preferred embodiment of the invention, the mixing step (step e) is carried out by adding between 50% and 90% by weight of said devulcanised material and between 10% and 50% by weight of said second fraction, relative to the total weight of said composition.

Preferably, said second fraction is present in an amount of between 5 and 30% by weight, preferably between 5 and 20% by weight, more preferably between 5 and 15% by weight, even more preferably between 5 and 10% by weight, relative to the total weight of the ready-to-crosslink composition.

The addition of said second fraction makes it possible to introduce virgin rubber (or compound based on virgin material) into mixing step e. The properties of the devulcanised mixture resulting from step (e), corresponding to the ready-to-crosslink rubber-based composition, will be modified following this addition. Depending on the expected properties, it is possible to vary the amount of said second fraction added.

In a preferred embodiment of the invention, the method is implemented by continuous extrusion to form said extruded strip. Therefore, after the selection step(s), the first devulcanised fraction is mixed according to the steps included in the method according to the invention. The direct and successive combination of devulcanisation and mixing step (e) is particularly advantageous for the user, who can offer a ready-to-crosslink and ready-to-use composition, i.e., ready to be vulcanised for recycling into a new final product.

In a preferred embodiment of the invention, said vulcanised elastomer waste is in the form of granules, chips, or powders.

According to an advantageous embodiment, said virgin elastomer is in the form of granules, chips, powders, or strips.

In a preferred embodiment of the invention, the method further comprises a step of cooling said devulcanised material.

In a preferred embodiment of the invention, all the steps of the method are carried out successively so as to provide said composition, ready for crosslinking, in the form of an extruded strip with a lifespan of more than 24 hours, which allows the composition to be easily stored upon delivery without losing the stated properties.

The lifespan corresponds to the duration during which the composition can be stored before use.

Other embodiments of the method according to the invention are indicated in the appended claims.

Within the scope of this invention, any singular article such as, for example, “a”, “an”, “the”, “the”, “of”, “of the” may be replaced by an article or expression that designates a plural such as, for example, “at least 2”, “at least 3”, “several”, etc.

The word “include”, “contains” or any equivalent term or derivative may be replaced by “consisting of” in order to define a list or exclusive selection possibilities so as not to include other elements not mentioned in the expression used.

Where percentages (%) are given, these are by weight unless otherwise stated.

Crosslinking, according to the invention, means a crosslinking of a rubber or elastomer with sulphur, which is more specifically called vulcanisation because sulphur is used as a vulcanising agent. The term “crosslinking,” which therefore includes vulcanisation, also refers to other types of crosslinking agents, such as peroxides. In the following, the terms “crosslinking” or “decrosslinking” will therefore include the terms “vulcanisation” and “devulcanisation,” respectively.

“Rubber” or “rubber-like material” are common terms for elastomers or elastomeric materials, which are more technical terms, and these common terms will be used below in this sense.

The adjective “used” used in this invention encompasses end-of-life, discarded, or stored waste products.

The term “bound sulphur” should be understood to mean sulphur that is bound to another S atom (S—S) or to a carbon atom (S—C). This term also refers to sulphur that could be referred to as partially bound, particularly when a devulcanisation step has been carried out. It is understood that this term indirectly characterises the composition according to the invention, in that it contains a certain amount of vulcanised and/or devulcanised elastomer waste. This bound sulphur can be detected by elemental analysis of an intensively washed rubber composition, for example by Soxhlet extraction, using a sulphur solvent.

The term “free sulphur” should be understood to mean sulphur that does not bind to the elastomer/rubber present in the composition. This free sulphur may come from the sulphur-based vulcanising agent and also, “optionally, from a vulcanisation accelerator, for example, CBS or TMTD. This free sulphur, in the presence or absence of the vulcanisation accelerator, may be recovered in solution during intensive washing of said composition according to the invention, for example, by Soxhlet extraction. Sulphur determination may be carried out using the PCS calcination method (standard NF EN 15408) and determination based on flue gas cleaning.

In a devulcanised rubber or devulcanised elastomer, some of the sulphur bonds are broken and remain partially bound. These bonds may be of the S—S (sulphur-sulphur) and/or C—S (carbon-sulphur) types. Thus, these sulphur-containing bonds form bridges between the macromolecular chains of the rubber. Devulcanisation breaks the bond that unites several macromolecular chains, but in most cases, the sulphur remains attached to a rubber macromolecule. The devulcanisation process allows for the recovery of used rubber material. More specifically, devulcanisation involves partially destroying the three-dimensional rubber network by breaking the carbon-sulphur or sulphur-sulphur bonds.

It is possible to determine the amount of sulphur in a composition by elemental analysis. To ensure that the quantity of sulphur measured during an elemental analysis corresponds to the quantity of sulphur bound to the rubber. The rubber composition can be intensively washed, for example by Soxhlet extraction, using a sulphur solvent. This washing solubilises any free sulphur that may be present in the rubber composition. Bound sulphur means sulphur that can be detected by elemental analysis in a washed rubber composition.

Sulphur dosing can be carried out using the PCS calcination method (NF EN 15408 standard) and dosing using flue gas cleaning.

The term “virgin rubber” or “virgin elastomer” should be understood to refer to rubber that has not undergone vulcanisation and therefore has not been devulcanised. This constitutes the non-recycled virgin raw material.

The first step a of the method according to the invention relates to a raw material selection step. This step consists of selecting from a certain number of waste materials, the raw material of interest that will constitute at least 50% by weight, preferably 51% by weight of a first fraction. This raw material is vulcanised, or used, elastomer waste.

More specifically, if this elastomer waste is a used aircraft tyre, for example, it can be recycled and processed to be transformed into vulcanised granules, chips, or powders. It is therefore possible that this fraction also contains other compounds resulting from the composition used to manufacture aircraft tyres.

This reasoning can be applied to all types of recycled raw materials, such as lorry and car tyres, or even elastic pads, seals, or membranes, preferably rubbers used in the construction or civil engineering fields. Each starting composition will be specific to the intended end product.

In addition, those skilled in the art are familiar with GTR (Ground Tyre Rubber) tyres, which comprise an elastomer selected from the group consisting of SBR, NR, SBR, and mixtures thereof.

The person skilled in the art also knows that this elastomer waste can also include other compounds such as carbon black, steel, etc. Any compound used in the manufacture of this type of tire is therefore included within the scope of this invention.

Grinding and granulating are the most commonly used methods for recycling these tyres.

The devulcanisation step partially breaks some of the S—C and S—S bonds present in the elastomer waste to make it suitable for the recovery provided for within the scope of this invention.

Although the person skilled in the art is familiar with devulcanisation techniques, this invention chooses to apply devulcanisation obtained by mechanical shearing, preferably under the action of heat (i.e., thermomechanical). This step may be followed by cooling and the addition of the vulcanising agent, the activating agent, and the additives to provide a so-called “active” composition, in that it only needs to be vulcanised at a certain vulcanisation temperature.

This devulcanisation is preferably carried out using an extruder on a continuous conveyor belt.

The devulcanisation carried out within the scope of this invention is advantageously carried out in the absence of a devulcanising agent or oils.

The mixing step (e) of this invention may be carried out in several ways.

According to an advantageous embodiment, the ready-to-crosslink rubber-based composition consists mainly of rubber devulcanised in the presence of an activating agent (ZnO), a vulcanising agent (S), and optionally a vulcanisation accelerator (CBS) and optionally additives.

Thus, the mixing step (e) took place with the devulcanised material, which mainly comprises devulcanised rubber.

According to this embodiment, it is therefore not necessary to add virgin rubber.

According to a preferred embodiment, it is possible to use a second fraction that comprises at least 30%, preferably a maximum of 20%, and more preferably a maximum of 10% by weight of a virgin elastomer.

In this case, the devulcanised material, which contains devulcanised rubber, is added to this second fraction.

Then, the activating agent (ZnO), the vulcanising agent (S), optionally the vulcanisation accelerator (CBS), and optionally the additives are added to the mixture containing the devulcanised material and the second fraction.

According to a particularly advantageous embodiment of the invention, it is also possible to directly add the activating agent (ZnO), the vulcanising agent (S), optionally the vulcanisation accelerator (CBS), and optionally the additives to the second fraction. This can also be achieved with the devulcanised material, which will thus comprise these same aforementioned elements.

The mixing step (e) will consist of mixing the second fraction containing all of the aforementioned elements with the devulcanised material, also consisting of the aforementioned elements, to form the ready-to-crosslink rubber-based composition according to the invention.

### EXAMPLE 1

TABLE 1

| Compounds | Quantity (% by weight) |
|---|---|
| Rubber consisting of 100% devulcanised | 92 |
| rubber from aircraft tyres | |
| ZnO | 4 |
| S | 1 |
| CBS | 1 |
| Stearic acid | 2 |

### EXAMPLE 2

TABLE 2

| Compounds | Quantity (% by weight) |
|---|---|
| Rubber consisting of 75% devulcanised | 92 |
| rubber from aircraft tyres and 25% | |
| virgin rubber | |
| ZnO | 4 |
| S | 1 |
| CBS | 1 |
| Stearic acid | 2 |

### EXAMPLE 3

TABLE 3

| Compounds | Quantity (% by weight) |
|---|---|
| Rubber consisting of 90% devulcanised | 92 |
| rubber from aircraft tyres and 10% | |
| virgin rubber | |
| ZnO | 4 |
| S | 1 |
| CBS | 1 |
| Stearic acid | 2 |

It is understood that this invention is in no way limited to the embodiments described above and that many modifications may be made thereto without departing from the scope of the appended claims.

1-15. (canceled)

16. A ready-to-crosslink rubber-based composition, in the form of an extruded strip, said composition comprising:
a) a total quantity of rubber of between 30% and 90% by weight or between 30% and 99% by weight;
b) a rubber activating agent in an amount of between 0.1% and 10% by weight;
c) a vulcanising agent which comprises sulphur, in an amount of between 0.5% and 5% by weight;
characterised in that said ready-to-crosslink composition comprises a total amount of bound sulphur selected from one of at least 0.25% by weight, between 0.25% and 10% by weight, or between 0.25% and 5% by weight, and an amount of free sulphur of between 0.1% and 5% by weight, each aforementioned % by weight being expressed relative to the total weight of the composition.

17. The composition according to claim 16, having a viscosity selected from one of between 20 and 85 Mooney or between 35 and 80 Mooney, as measured according to the ISO-289 standard.

18. The composition according to claim 16, further comprising a rubber vulcanisation accelerator in an amount of between 0.5% and 5% by weight, relative to the total weight of the composition.

19. The composition according to claim 16, further comprising additives selected from the group consisting of reinforcing fillers, diluting fillers, fatty acids, stearic acid, plasticisers, anti-ozone protectors, antioxidants, oils, and mixtures thereof.

20. The composition according to claim 16, wherein the activating agent is selected from the group consisting of zinc oxide.

21. The composition according to claim 16, wherein said rubber is derived from a devulcanised rubber that is present in an amount of between 50% and 100% by weight relative to the total weight of rubber.

22. The composition according to claim 21, wherein said devulcanised rubber is derived from a vulcanised elastomer waste selected from the group consisting of ethylene-propylene-diene monomer (EPDM), styrene-butadiene (SBR), natural rubber (NR), synthetic isoprene (IR) and mixtures thereof, in the form of chips, granules, or powders.

23. The composition according to claim 16, wherein said rubber is obtained by mixing an amount of between 50% and 90% by weight of devulcanised rubber and an amount of between 10% and 50% by weight of virgin rubber, said % by weight being expressed relative to the total amount of rubber.

24. A method for manufacturing a ready-to-crosslink rubber-based composition, to form an extruded strip, said method comprising the following steps:
a) selecting a first fraction comprising at least 50% by weight of a vulcanised elastomer waste selected from the group consisting of ethylene-propylene-diene monomer (EPDM); styrene-butadiene (SBR), natural rubber (NR), synthetic isoprene (IR) and mixtures thereof, and wherein said vulcanised elastomer waste has a quantity of bound sulphur selected from one of at least 0.25% by weight, between 0.25% and 10% by weight, or between 0.25% and 5% by weight;
b) devulcanisation by (thermo)chemical or (thermo)mechanical means of said first fraction to obtain a devulcanised material;
c) optionally, selecting a second fraction comprising at least 30% by weight of a virgin elastomer selected from the group consisting of ethylene-propylene-diene monomer (EPDM), styrene-butadiene (SBR), natural rubber (NR), synthetic isoprene (IR) and mixtures thereof,
d) optionally, adding said devulcanised material to said second fraction;
e) mixing the material obtained in step b or step d, with at least one rubber activating agent and a vulcanising agent which comprises sulphur with formation of a devulcanised mixture corresponding to said ready-to-crosslink rubber-based composition;
characterised in that said ready-to-crosslink rubber-based composition obtained during the mixing of step (e) comprises one of 0.25% by weight, between 0.25% and 10% by weight, or between 0.25% and 5% by weight of bound sulphur, and between 0.25 and 2% by weight of free sulphur, relative to the total weight of the composition.

25. The method according to claim 24, wherein the mixing step of step (e) is carried out by adding between 50% and 100% by weight of said devulcanised material, relative to the total weight of said composition.

26. The method according to claim 24, wherein the mixing step (e) is carried out by adding between 50% and 90% by weight of said devulcanised material and between 10% and 50% by weight of said second fraction, relative to the total weight of said composition.

27. The method according to claim 24, being carried out by continuous extrusion to form said ready-to-crosslink extruded strip.

28. The method according to claim 24, wherein said vulcanised elastomer waste or said virgin elastomer is in the form of granules, chips, or powders.

29. The method according to claim 24, further comprising a step of cooling said devulcanised material.

30. The method according to claim 24, wherein all the steps of the method are carried out successively so as to provide said ready-to-crosslink composition in the form of an extruded strip having a lifespan of at least 24 hours.
